(19) United States
(12) Patent Application Publication
(10) Pub. No.: US 2025/0147926 A1
(43) Pub. Date: May 8, 2025

(54) Method for managing access to description files associated with a content broadcast in real time

(71) Applicant: ORANGE, ISSY LES MOULINEAUX (FR)

(72) Inventors: Olivier Gaste, Chatillon Cedex (FR); Hervé Marchand, Chatillon Cedex (FR)

(21) Appl. No.: 18/938,757

(22) Filed: Nov. 6, 2024

(30) Foreign Application Priority Data
Nov. 7, 2023 (FR) 2312047

(51) Int. Cl. G06F 16/13; G06F 16/23

(52) U.S. Cl. CPC G06F 16/13; G06F 16/23

(57) ABSTRACT

A method for managing access to description files associated with a content broadcast in real time, the reading requiring reception, from a communication network, of description files of a first type and of a second type. The method includes reception, following a request for access to a content, of a description file of the second type and also of successive description files of the first type; and wherein the description file of the second type received is supplemented over time by at least some of the description files of the first type received successively.

### CROSS-REFERENCE TO RELATED APPLICATIONS

The present application claims priority to French Patent Application FR 2312047, filed Nov. 7, 2023, the content of which is hereby incorporated by reference in its entirety.

### TECHNICAL FIELD

The field of the present disclosure is that of managing access to description files associated with a multimedia content broadcast in real time.

More particularly, the present disclosure applies to segmented contents, the segments being accessible in a plurality of formats associated with respective sizes in bytes having a greater or lesser impact on the bandwidth of the network on which the content is downloaded. The present disclosure is particularly applicable to content downloaded by what is called a progressive adaptive downloading technique, or HAS, or any other downloading techniques using the same principle.

It should be noted that the segment addresses are included in a description file. In the context of progressive adaptive downloading, a description file is a file comprising, among other information, IP addresses of the segments to be downloaded and read by a reading device. In other words, a description file describes segments in the form of IP addresses, to be used by the reading device for accessing these segments via the internet.

“Reading device” denotes any data processing device equipped with processors and capable of accessing content segments via a network, of receiving the segments from a network, of decoding the received segments and of requesting a rendering of the decoded segments, for example on a screen integrated into the reading device or external to the reading device.

### PRIOR ART

When accessing a multimedia content, a reading device sends a request to a content server, stating the chosen multimedia content (video and/or audio). In return, the reading device receives a stream of digital data relating to this content. In the context of a local communication network, such a request may pass through a network access gateway, for example a residential gateway.

The received data are then decoded by the reading device and then rendered in the form of a display of the corresponding video.

The broadcasting of digital content over the internet is commonly based on client-server protocols of the HTTP (Hyper Text Transport Protocol) type. In particular, downloading in progressive mode (or HTTP Adaptive Streaming, abbreviated to HAS) of digital content, also called “adaptive streaming”, enables data to be transported and read in real time; that is to say, the digital data are transmitted over the network and rendered by the reading device progressively as they arrive. Following the reception of the stream, the reading device stores the received data in a buffer memory before rendering them. This distribution mode is particularly useful when the bit rate available to the user is not guaranteed for the real-time transfer of the video.

Progressive adaptive downloading also enables data to be broadcast and received in different qualities, corresponding for example to respective different encoding rates. These different qualities are described in a description file, also called a “manifest” by those skilled in the art.

When a user accesses the live stream broadcast in HTTP Adaptive Streaming (HAS), the reading device successively retrieves, at regular intervals, usually every two seconds, description files, referred to hereafter as description files of a first type, each of which usually describes the last sixty seconds of the stream (30 segments of 2 seconds each), while supplying IP (Internet Protocol) addresses of segments corresponding to these last sixty seconds.

The chosen video segments are usually of short duration, since it is desirable to be as close as possible to the stream broadcast in real time, also known to those skilled in the art as the “live stream”.

It should be noted that an encoding rate is selected from among the available rates according to the available bandwidth or the storage and decoding capacities of the reading device. This type of technique makes it possible to take into account the variations of bandwidth in the link between the client reading device and the content server.

In addition to reading content, some reading devices offer a function referred to by those skilled in the art as “Start Over”, which enables a user watching a content broadcast in real time (live stream) to re-read some of the content that has been broadcast live; notably, this function enables a content to be re-read from its beginning. For example, if a film broadcast in real time starts at 21.00 and the user accesses the corresponding live stream by switching to the channel at 21.40, the user, by selecting a command related to the so-called start-over function, can request the reading of the content to resume, for example, from the start of the film. In this case, there is a switch from a real-time reading mode to a start-over mode.

In this start-over mode, a command interface offers the option of selecting one or more commands that modify the current reading of the content broadcast in real time. These commands may be used, for example, to interrupt the reading, or to make a time hop to re-read the content from an earlier reading instant, so that the content is read in delayed mode.

If a content is read and the so-called start-over function is not offered, then in this case the description files received successively, referred to below as description files of the first type, are those described above. On the other hand, if the so-called start-over function is available, the reading device receives successively, from the start of the reading of the content, special description files, referred to below as description files of the second type, which describe, instead of the last sixty seconds, a wider time range, commonly several hours in length, for example the last four hours, so that the content can be re-read starting from an instant located in the four-hour time frame.

Such a description file of the second type, describing the last four hours for example, is two hundred and forty (240) times larger than a conventional description file. Specifically, a description file of the first type has a size of about 12 KB (a description of 30 segments of 2 seconds each), and a description file of the second type has a size of about 2.8 MB (a description of 7200 segments of 2 seconds each).

Just like the description file of the first type, the description file of the second type is downloaded periodically, once every two seconds for example. Because of its very large size, the periodic transmission of the description file of the second type requires a very large network bandwidth, which may have a negative effect on the quality of service during the rendering of the content, especially for homes having a low-speed internet line such as an ADSL line; furthermore, such description files require excessively long processing times (parsing times), which may have a negative effect on the regular reading of the content if the processing capacity of the reading device is poor, possibly leading to image freezes that are unacceptable to a user.

One or more exemplary aspect of the present disclosure is intended to improve the situation.

### SUMMARY

To this end, according to a first functional aspect, the disclosure relates to a method for managing access to description files associated with a content broadcast in real time, the reading requiring reception, from a communication network, of description files of a first type or of a second type, wherein the method comprises reception, following a request for access to a content, of a description file of the second type and also of successive description files of the first type; and wherein the description file of the second type received is supplemented over time by at least some of the description files of the first type received successively.

According to an aspect of the present disclosure, the description file of the second type is received at a given instant and supplemented (or updated) by the reading device on the basis of description files of the first type received successively after this instant by the reading device.

If there are commands requesting the reception of a description file of the second type because the so-called start-over function is available, an aspect of the present disclosure makes it unnecessary to receive only the files of the second type one after another as in the prior art.

According to an aspect of the present disclosure, a single description file of the second type could be transmitted initially and then supplemented by the descriptions of segments obtained from the description files of the first type received successively. However, an aspect of the present disclosure does not rule out the option of receiving a plurality of description files, at regular intervals for example, followed by groups of description files of the first type, respectively.

The transmission of a limited number of description files of the second type and the transmission of description files of the first type, smaller in terms of byte size, which will supplement the description file of the second type, results in a very large gain in bandwidth in the network that carries the description files.

According to an aspect of the present disclosure, a description file of the second type is created outside the reading device, in the content server or in a server associated with this content server, and is kept updated on the reading device.

According to a first embodiment of the method, if received files of a first type and of a second type describe the same segments, the segments concerned are read on the basis of the received description file of the first type. When description files of the second type are received, a management entity checks whether a simultaneously received file of the first type describes identical segments. This embodiment will be applied essentially to the first segments to be read, because, as indicated below, the first segments to be read may be included in both the file of the second type and a file of the first type. This embodiment avoids the use of a description file of the second type for reading the stream in real time, since this file is large in terms of byte size and therefore takes longer to scan. Rendering may be delayed, thus creating a time lag relative to the live stream.

According to yet another particular embodiment of the disclosure, which may be implemented as an alternative or in addition to the preceding embodiment, an update is performed on the basis of all the description files of the first type received. The advantage of an update on the basis of all the description files of the first type is that, ultimately, the description file of the second type is complete, and re-reading is possible from any segment that has already been broadcast.

According to yet another particular embodiment of the disclosure, which may be implemented as an alternative or in addition to the preceding embodiments, an update is performed on the basis of some of the description files of the first type received. Because of the update on the basis of some of the description files of the first type, the description file of the second type is incomplete and therefore smaller than a conventional description file of the second type; consequently, this embodiment simplifies the CPU processing in the reading device, and the reading device reads the description file of the second type more quickly.

According to yet another particular embodiment of the disclosure, which may be implemented as an alternative or in addition to the preceding embodiments, the description file of the second type describes a number of segments that is constant over a given time range; and an update of a given number of descriptions of segments via a description file of the first type results in a deletion in the description file of the second type of the same number of descriptions of segments among the first segments of the time range. Thus the management entity manages the size of the description file of the second type locally to keep it constant.

According to yet another particular embodiment of the disclosure, which may be implemented as an alternative or in addition to the preceding embodiments, a plurality of description files of the second type are received successively at regular intervals; in this configuration, the reception of a description file of the second type causes the deletion of the current description file of the second type. As a result of this embodiment, the reading device does not store expired description files of the second type that would encumber the memory space available on this device.

According to yet another particular embodiment of the disclosure, which may be implemented as an alternative or in addition to the preceding embodiments, the description file of the second type received describes a number of segments over a given time range, and the time range increases over time. As a result of this embodiment, the time range associated with the segments accessible in re-read mode increases, and enables a user to re-read a segment over a wider time range than when the time range is constant, for example four hours.

According to a first material aspect, the disclosure relates to a management entity for managing access to description files associated with a content broadcast in real time, the reading requiring reception, from a communication network, of description files of a first type and of a second type, wherein it comprises a processor configured for executing the following steps:
receiving, following a request for access to a content, both a description file of the second type and successive description files of the first type;
supplementing the description file of the second type received with at least some of the description files of the first type received successively.

According to another material aspect, the disclosure relates to a reading device comprising a management entity as defined above.

According to another material aspect, the disclosure proposes a computer program capable of being implemented in a management entity as defined above, the program comprising code instructions which, when it is executed by a processor, implement the steps of the management method defined above.

According to another material aspect, the disclosure proposes a data medium on which has been stored at least one set of program code instructions for the execution of a management method as defined above.

According to a second functional aspect, the disclosure relates to a method for managing the transmission of description files associated with a content broadcast in real time, the reading requiring reception, from a communication network, of description files of a first type or of a second type, wherein the method comprises the transmission, following a request for access to a content, of a description file of the second type and of description files of the first type successively.

As indicated below, a description file of the second type can be transmitted on its own or simultaneously with a description file of the first type.

According to a particular embodiment of the second entity, the description file of the second type is transmitted after a given period.

According to a particular embodiment of the second entity, which may be implemented as an alternative or in addition to the preceding embodiment, the description file of the second type is transmitted after a given number of transmissions of description files of the first type.

The preceding two embodiments cover the fact that the description file of the second type is not necessarily the first description file transmitted following the reception of the request for access to the content being broadcast; on the contrary, the description file of the second type is transmitted later, either after a given period or after a given number of description files of the first type have been transmitted. These two embodiments are based on the principle that a user accessing the content does not usually require a re-read in the first minutes. The given period or the given number mentioned above will also be chosen appropriately in order to allow for the time spent by the user before re-reading a content.

According to another material aspect, the disclosure relates to a management entity, called the second entity, for managing the transmission of description files associated with a content broadcast in real time, the reading requiring transmission, via a communication network, of description files of a first type or of a second type, wherein it comprises a processor configured for executing the following steps:
receiving a request for access to a content,
following the reception of a command for access to a content, transmitting both a description file of the second type and description files of the first type successively.

According to another material aspect, the disclosure relates to a content server comprising a second entity as defined above.

According to another material aspect, the disclosure relates to a computer program capable of being implemented in a second management entity as defined above, the program comprising code instructions which, when it is executed by a processor, implement the steps of the method defined in relation to the second functional aspect.

Finally, according to another material aspect, the disclosure relates to a data medium on which has been stored at least one set of program code instructions for the execution of a method for managing the transmission of description files.

The aforementioned media may be any entity or device capable of storing the program. For example, a medium may comprise a storage means such as a ROM, for example a CD-ROM or a microelectronic circuit ROM, or a magnetic recording means such as a hard disk. On the other hand, a data medium may be a transmissible medium such as an electrical or optical signal which may be routed via an electrical or optical cable, wirelessly, or by other means. The program according to an aspect of the disclosure can, in particular, be downloaded from a network such as the internet. Alternatively, the data medium may be an integrated circuit in which the program is incorporated, the circuit being adapted to execute or to be used in the execution of the method in question.

### BRIEF DESCRIPTION OF THE DRAWINGS

Aspects of the disclosure will be more clearly understood from a perusal of the following description, provided by way of example, which refers to the attached figures, in which:

FIG. 1 shows an architecture for progressive downloading from the internet, based on the use of adaptive streaming according to one embodiment of the method of the disclosure;

FIG. 2 shows schematically the hardware structure of a server for transmitting description files;

FIG. 3 shows schematically the hardware structure of a reading device for reading multimedia streams in real time;

FIG. 4 shows a content and the available segments for this content;

FIG. 5 shows an embodiment of the method of the disclosure; this figure shows the communication between the reading device and the content server and the type of description files transmitted as a function of time. In this embodiment, the description file of the second type is transmitted first, following the request for access to a content; the files of the first type are transmitted subsequently.

FIG. 6 shows another embodiment that can be implemented as an alternative or in addition to the preceding embodiment; in this embodiment, the description file of the second type is transmitted after the transmission of a certain number of files of the first type.

FIG. 7 shows another embodiment in which the description file of the second type is transmitted several times, for example regularly, each transmission being followed by a transmission of description files of the first type.

### DETAILED DESCRIPTION OF EMBODIMENTS OF THE DISCLOSURE

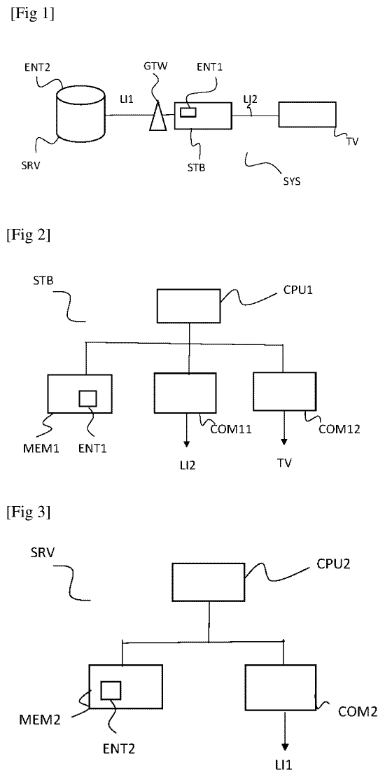

FIG. 1 shows a data processing system SYS in which is implemented a content distribution network (CDN), as it is termed by those skilled in the art, from which contents and description files associated with the multimedia contents are transmitted to client devices or content reading devices.

In our example, the system comprises a single reading device STB. However, the present disclosure is applicable to any number of reading devices.

The reading device is, for example, a digital reading device such as a decoder.

The multimedia content considered here is a video content, corresponding for example to a television channel on which are broadcast television programs called “live”, that is to say broadcast in real time. The content in question is broadcast in multicast mode.

In our example, the reading device STB is connected to a rendering terminal TV such as a television.

In our example, the reading device STB is connected to a port of the rendering device TV; the reading device STB and the rendering device TV could also form a single device.

In our example, the reading device STB is located in a local network LAN (abbreviation for “Local Area Network”) managed by a domestic gateway GTW. The context of a local network is given by way of example, and could easily be transposed to an internet of the “best effort” type, a company network, etc. As shown below, the reading device STB comprises a first management entity ENT1.

The gateway GTW can communicate via a telecommunication network LI1 such as a WAN wide area network, known to those skilled in the art.

The data processing system SYS implements a content distribution network (CDN), as it is termed by those skilled in the art, from which contents are transmitted to client devices or content reading devices STB.

The CDN network is composed of servers connected in a network within the wide area network; these servers interact in order to make multimedia contents available to users in unicast mode. To simplify the description of an aspect of the disclosure, a single content server SRV is shown in FIG. 1 to represent the CDN. In our example, the content server SRV is located in the WAN wide area network.

The content server SRV receives, for example, digital television content channels from a television broadcast network (not shown), and makes them available in real time to client terminals, in this case the reading device STB.

The contents CNT are made available in unicast mode in a given format. Such a content CNT is, for example, a content downloaded in adaptive streaming mode. The MPEG-DASH (Dynamic Adaptive Streaming over HTTP) standard is a standard for an audiovisual broadcasting format for use on the internet; this standard is based on the preparation of the content in different representations of variable quality and speed, cut into segments of short duration (of the order of a few seconds), also called “chunks” by those skilled in the art. Each of these segments is made available individually by means of an exchange protocol between the rendering terminal and the server supplying multimedia contents. The protocol mainly targeted is the HTTP protocol, but other protocols (for example FTP) may also be used. The organization of the segments and the associated parameters are published in a description file in XML format. The details of this downloading mode will not be discussed further as they are irrelevant to the disclosure of the invention.

An example of a description file or “manifest” (MPD) according to the MPEG-DASH standard, comprising the description of contents available in three different qualities (N1=512 kb/s, N2=1024 kb/s, N3=2048 kb/s) of the fragmented contents is given in Appendix 1. This simplified description file describes the digital contents in an XML (extended Markup Language) syntax, comprising a list of contents in the form of segments conventionally described between an opening tag (<SegmentList>) and a closing tag (</SegmentList>). The division into segments makes it possible, notably, to provide fine adaptation to fluctuations of bandwidth. Each segment corresponds to a certain duration (the “duration” field) with several quality levels, and enables their addresses (URL, for Uniform Resource Locator) to be generated. This generation is carried out in this example by using the elements “BaseURL” (“HTTP://server.com”), indicating the address of the content server, and “SegmentURL”, listing the complementary parts of the addresses of the different segments:
“C1_512kb_1.mp4” for the first fragment of the content “C1” at 512 kilobits per second (“kb”) in the MPEG-4 format (“mp4”),
“C1_512kb_2.mp4” for the second fragment, and so on.

In FIG. 2, the server SRV is also equipped with at least one processor CPU2 and memories MEM2 for data processing. The server is also equipped with a management entity ENT2, called the second management entity, which can manage the transmission of a content and of the description file associated with the content from the server SRV to one or more reading devices, in this case to the reading device STB. The server SRV communicates with the gateway GTW via the WAN network. The server comprises, for communication with the WAN network, a communication module referenced COM2 in 20 FIG. 3. The following discussion will mainly be concerned with the transmission of the description file, rather than the transmission of the segments.

FIG. 3 shows an architecture of a reading device STB. This device STB conventionally comprises memories MEM1 associated with a processor CPU1. The memories may be of the ROM (Read Only Memory) or RAM (Random Access Memory) type, or possibly the Flash type.

The reading device STB can transmit a content to be rendered to the rendering device TV via a communication module COM12. This module COM12 is, for example, an HDMI link.

The reading device STB communicates with the gateway via an Ethernet module for local wired communication or via a wireless module of the WiFi type for local wireless communication with the residential gateway GTW. The module in question is denoted CMO11 in FIG. 2.

The reading device STB comprises a module for downloading in HAS streaming mode (not shown) which is capable of managing the downloading of segments of the content. The reading device STB also comprises a management entity ENT1, referred to below as the second management entity, which is capable of reading a description file constructed specifically during reading in start-over mode as explained below. The HAS download module and the first entity ENT1 may form a single entity, in which case the HAS module is integrated with the first entity ENT1, or they may be separate from each other.

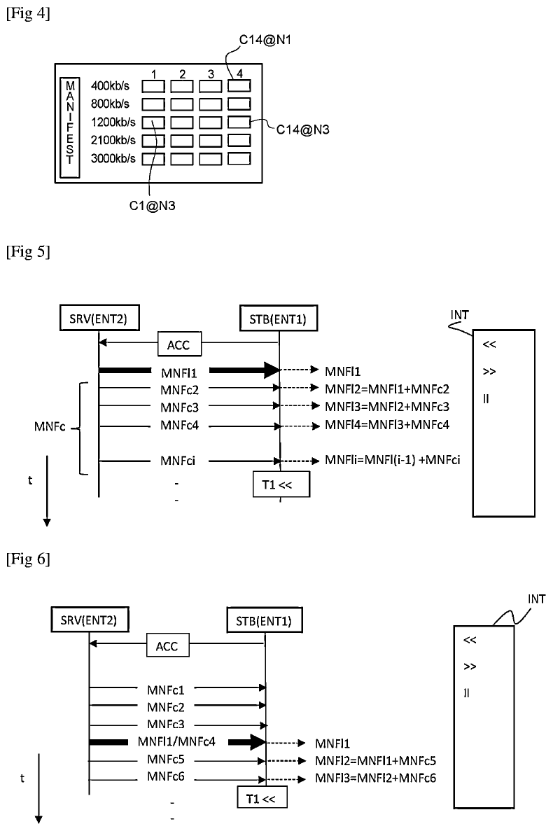

A schematic view of a main content C1 divided into segments and stored in the content server SRV will now be described with reference to FIG. 4. More precisely, the HAS content server shows a video C1 in the form of segments C1i@Nj encoded at different encoding rates Nj, where the index i denotes a temporal identifier of the segment C1i@Nj.

The HAS download module, referred to below as the conventional downloading mode, of the reading device STB has the task of retrieving the segments from the HAS content server, choosing the video quality Nj according to the available network resources. The manner in which the HAS download module chooses the encoding rate of the next video segment to be downloaded will not be described in detail here. It will be recalled that the general principle of such algorithms is usually based on the downloading of a first segment at the lowest encoding rate offered in the description file, and on the evaluation of the retrieval time of this first segment. On this basis, the HAS download module evaluates whether, according to the size of the segment and the time taken to retrieve it, the network conditions enable the next segment to be downloaded at a higher encoding rate. Some algorithms are based on a progressive increase in the quality level of the downloaded content segments; others offer more risky approaches, with jumps in the levels of the encoding rates of the successive segments.

In the conventional case, if a video segment lasts for three seconds, the retrieval of the segment by the HAS download module must not exceed 3 seconds, in order to allow the uninterrupted rendering of the content by the reading device STB. It is therefore desirable for the HAS download module to achieve the best compromise between a rendering quality, and therefore an encoding rate, that is as high as possible, and the segment download time, which must be short enough to allow continuous rendering on the television TV.

Initially, the HAS module retrieves the description file corresponding to the video content C1 in order to discover the available segments of the video content C1 and the different video qualities Nj associated with them. In the example of FIG. 4, the content C1 is, for example, offered in the form of segments with a duration of 3 s, with a first encoding rate N1 of 400 kb/s, a second encoding rate N2 of 800 kb/s, a third encoding rate N3 of 1200 kb/s, and so on.

In a normal operating mode, not shown in FIG. 4, the HAS module downloads, for example, the successive segments C11@N1 (i.e. the first time segment at an encoding rate of 400 kb/s), then C12@N3 (i.e. the second time segment at an encoding rate of 1200 kb/s), then C13@N3 (i.e. the third time segment at an encoding rate of 1200 kb/s), and so on.

The different segments downloaded by the HAS download module are then transmitted to a display module that can request a display on the television TV.

The algorithm used by the HAS download module to determine which segment, at which encoding rate, is to be downloaded in the normal operating mode may be one of the existing prior art algorithms. Consequently this algorithm will not be detailed further here.

Occasionally, the start of a televised program (film, series, etc.) is missed. A function called “start over” or “restart” may be used, at any time, to restart the program being broadcast at an instant preceding the current instant; for example, the reading of the content may be resumed from its beginning. For example, if a film starts at 21.00 and the user switches to the channel at 21.40, he may ask for the reading of the content to resume from the start of the film. In this case, therefore, there is a switch from a real-time reading mode to a delayed reading mode.

When this user accesses a live stream broadcast in real time (live content) by HTTP adaptive streaming (HAS), the reading device STB, provided that the HAS entity is installed on the device, usually retrieves a description file every 2 seconds, said file being referred to below as the description file of the first type, which usually describes the last sixty seconds of the stream (30 segments of 2 seconds each). It may then be decided that some of the stream (up to a maximum of 60 seconds, therefore) is to be stored in a memory (buffer); the video segments are of short duration, because it is desirable to remain as close as possible to the true live event, that is to say the filmed event, for example a football match. For this reason also, the description file is retrieved every two seconds and the buffer depth is usually limited to about fifteen seconds, to avoid creating an excessive lag between the football match and its rendering on a screen.

A command interface (the symbols most commonly present on a remote controller are “<<” for backward, “>>” for fast forward and “II” for the pause command) may be used to act on the current reading of the live content. In particular, some commands may be used to activate the start-over mode.

To ensure the execution of a command on the command interface, for example the “back” command, <<, the description file that is retrieved now describes, instead of the last sixty seconds, a time frame of considerably more than sixty seconds. The time frame in question may relate to the last four hours; in this case, the content can be re-read from an instant located in the time frame.

This description file, called a description file of the second type, describing the last four hours, is transmitted periodically (usually every two seconds), independently of whether or not the start-over mode is used.

A description file of the first type will be denoted MNFc (where the index “c” denotes a “short” description file), and a description file of the second type will be denoted MNFI (where the index “I” denotes a “long” description file).

Evidently, therefore, in this case the description file of the second type is larger than the description file of the first type.

According to an aspect of the disclosure, when access to the content is requested, the server transmits in return a description file of the second type MNFI and files of the first type MNFc; the first entity ENT1, after receiving the description file of the second type MNFI, has the task of updating the description file of the second type received with some or all of the description files of the first type received successively.

In FIGS. 5 to 7 described below, in order to distinguish the description files of the first and second types, the streams carrying the description files of the second type are shown with a thicker arrow than the streams carrying the description files of the first type MNFC.

FIG. 5 shows an embodiment of the method of the disclosure. This FIG. 5 shows two vertical axes, corresponding respectively to two entities, namely the first entity ENT1 present on the reading device STB and the second entity ENT2 present on the server SRV. FIG. 5 shows the data exchanges that take place between the reading device STB and the content server SRV.

On the right of the two axes, a box is represented to show which commands are available via a command interface INT throughout the reading. This contains commands such as:
a back command “<<”,
a pause command “II”,
a fast forward command “>>” (this command cannot be used if the reading is already in delayed mode).

It should be noted that, in this FIG. 5, only some of the messages, useful for the understanding of the disclosure, are shown. For example, after a description file has been received by the reading device STB, the latter requests, in principle, access to the segments described in this received description file; we have chosen not to show these access messages, as they are irrelevant to the disclosure of the invention.

The execution of the commands shown above by way of example requires a delayed reading of the live content being broadcast. Evidently, the interface may include other commands that do not have such an effect on the current reading; such a command is, for example, a command to display information about the content being read.

The commands whose execution requires a delayed reading of the content require a description of segments that have been broadcast in the past; therefore, a file of the first type that describes only the last segments produced relating to the real-time broadcast is not sufficient. The first entity ENT1 therefore has the task of retrieving at least one description file of the second type MNFI1 to enable a command to be executed correctly.

The steps of an embodiment are as follows: it is assumed here that the command interface comprises at least one command requiring a delayed reading, and therefore requiring description files of the second type; it is also assumed that the user is accessing a “live” channel at 10.00 hours and that the program in question started at 9.00, that is to say one hour previously.

In a first step, the first entity ENT1 requests access ACC to a multimedia content.

In a second step, the server SRV, and therefore the second entity ENT2, receives the request.

In a third step, according to one embodiment, the second entity ENT2 automatically requests the initial transmission of a first description file of the second type MNFI1, describing both the segments relating to the live stream and the segments that have been broadcast since the start of the program four hours ago.

In this step, in our example, the server SRV may also transmit, independently of the description file of the second type, a description file of a first type describing the segments relating to the live stream.

If the files of a first type and of a second type are received and describe the same segments, the segments concerned are preferably read on the basis of the description file of the first type received, in order to save time.

Let us assume that only the description file of the second type MNFI1 is transmitted initially, this file comprising the description of the segments produced on the server relating to the content being broadcast in real time. In this case, the first segments are read by means of this description file of the second type MNFI1.

The second entity ENT2 then transmits successively description files of the first type MNFc2, MNFc3, . . . MNFci (where the index “i” denotes the i-th description file). The reading device STB receives these description files of the first type MNFc2, MNFc3, . . . MNFci and reads them one after another in order to access the segments.

In our example, after each reception of a description file of the first type, the description file of the second type MNFI1 is updated to include the addresses of segments received.

Evidently, at this stage, because of the updating of the description file of the second type over time, a request for the execution of a command to re-read the stream can be successfully met due to this updated description file of the second type.

According to one embodiment, the description file of the second type MNFI1 describes a constant number of segments over a given time range, for example a number of segments the reading of which covers four hours of broadcasting; in this configuration, an updating of a given number of descriptions of segments via a description file of the first type causes the deletion of the same number of descriptions of segments from among the first segments of the time range.

According to another possible variant of this embodiment, the description file of the second type MNFI1 can also be updated without any size limit. In this configuration, the time range for access to the previous segments increases with time; in our example, this period increases from an initial period of four hours.

With reference to this other variant, it is nevertheless possible to set a maximum size in order to avoid overloading the servers that store the contents.

In our example, the description files of the first type MNFc are transmitted at regular intervals (every 2 seconds, for example). It should be noted that, in our example, the different files are evidently different because they describe different segments.

It should be noted that the regularity with which the description file is sent is not essential; other ways of transmitting the file may be envisaged.

As stated above, the first description file of the second type MNFI1 is supplemented by the IP addresses of the segments described in the description files of the first type received successively. The first description file of the second type supplemented by the description file MNFc1 becomes MNFI2, the first description file of the second type MNFI2 supplemented by the description file MNFc2 becomes MNFI3, and so on.

With reference to FIG. 5, it is assumed that, at an instant T1, a user selects the back command << on his remote controller.

The decoder STB receives the command <<. The first entity ENT1 receives the command and requests its execution by the processor. The HAS download module can then access the requested segments.

FIG. 6 shows another embodiment that can be implemented in association or in combination with the embodiment described with reference to FIG. 5.

This FIG. 6 shows the same two vertical axes as those described with reference to FIG. 5, corresponding respectively to two entities, namely the first entity ENT1 present on the reading device STB and the second entity ENT2 present on the server SRV. FIG. 6 also shows the data exchanges that take place between the reading device STB and the content server SRV. On the right of the two axes, a box is represented to show which commands are available via a command interface INT throughout the reading. This contains commands such as:
a back command “<<”,
a pause command “II”,
a fast forward command “>>” (this command cannot be used if the reading is already in delayed mode).

In this embodiment, by contrast with the embodiment described in FIG. 5, the description file of the second type received initially is received later, for example after a given period following the request for access ACC, or after the transmission of a given number of files of the first type.

In this embodiment, the server SRV delays the transmission of the description file of the second type either to after a given period, or to after a given number of description files of the first type have been transmitted. These two embodiments are based on the principle that a user accessing the content does not usually require a re-read in the first minutes. The given period or the given number mentioned above will also be chosen appropriately in order to allow for the time spent by the user before re-reading a content.

In our example, with reference to FIG. 5, the file of the second type MNFI1 is transmitted after the third description file of the first type MNFc3. In our example, this file of the second type is transmitted at the same time as the fourth file of the first type MNFc4; however, these two files could also have been transmitted one after the other.

On reception, the first entity ENT1 stores the description file of the second type MNFI1 in anticipation of a possible request for execution of a command to re-read the content from an earlier instant. The first entity ENT1 also continues to read the segments on the basis of the file of the first type received MNFc4, and so on.

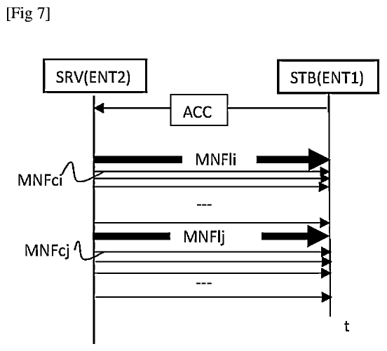

FIG. 7 shows another embodiment that can be implemented in association or in combination with the embodiments described above with reference to FIGS. 5 and 6.

In this embodiment, a plurality of description files of the second type MNFI1/ . . . MNFi/MNFj/ . . . (i and j are integers and j>i) are received successively at regular intervals. Transmissions of description files of the first type are interleaved between the transmissions of description files of the second type.

Additionally, in this embodiment, reception of a description file of the second type MNFIj causes the deletion of the current description file of the second type MNFIj used by the first entity ENT1; following the deletion, the last file of the second type received MNFlj is updated by the different description files of the first type MNFci (i=1,2,4, etc.) subsequently received successively, and is used for a possible re-reading of the content.

As mentioned above, a description file of a second type MNFli is updated by description files of the first type MNFci (i=1,2,4, etc.) subsequently received successively.

Finally, it should also be noted here that the term “entity” may equally well signify a software component or a hardware component or a set of hardware and software components, a software component itself signifying one or more computer programs or sub-programs or, more generally, any element of a program capable of executing a function or a set of functions as described for the modules concerned. Similarly, a hardware component signifies any element of a hardware assembly capable of executing a function or a set of functions for the module concerned (integrated circuit, smart card, memory card, etc.).

### Appendix 1: Example Manifest File

```
<?xml version:“1.0”?>
<MPD xmins:xsi=“http://www.w3.org/2001/XMLSchema-instance”
  xmins=“um:mpeg:DASH:schema:MPD:2011”
  xsi:schemaLocation=“urn:mpeg:DASH:schema:MPD:2011 DASH-
  MPD.xsd”
  type=“dynamic” profiles=“urn:mpeg:dash:profile:isoff-live:2011”>
<Representation id=“0” codecs=“avc1” mimeType=“video/mp4”
width=“1024” height=“766” startWithSAP=“1” bandwidth=“46966”>
<BaseURL>HTTP://server.com/</BaseURL>
<!-- Content C1 at N1=512kb -->
<SegmentBase>
    <Initialization sourceURL =“C1_1Ssec_512kb/C1_512kbit_
    dash,mp4”/>
</SegmentBase>
<SegmentList duration=“10”>
    <SegmentURL media=“C1_512kb_1.mp4”/>
    <SegmentURL media=“C1_512kb _2.mp4”/> ....
</SegmentList>
<!-- Content C1 at N2-1024kb -->
<SegmentBase>
    <Initialization sourceURL =“C1_15sec_500kbit/C1_1024kbit_
    dash.mp4”/>
</SegmentBase>
<SegmentList duration=“10”>
    <SegmentURL media=“C1_512lb_1.mp4”?>....
</SegmentList>
<!-- Content C1 at N3=2048kb -->
<SegmentBase>
    Initialization sourceURL=“C1_15sec_512kb /C1_2048kbit_
    dash.mp4”/>
</SegmentBase>
<SegmentList duration=“10”>
    <SegmentURL media-“C1_2048kb _1.mp4”?>...
</SegmentList>
<!-- Content C2 at N1=512kb -->
<SegmentBase>
    <Initialization sourceURL=“C2_500kbit/C2_512kbit_dash.mp4”/>
</SegmentBase>
<SegmentList duration=“10”>
    <SegmentURL media=“C2_512kb_1.mp4”/> ....
<SegmentList>
<!-- Content C2 at N2=1024kb -->
<SegmentBase>
    Initialization sourceURL=“C2_1Ssec_500kbit/C1_1024kbit_
    dash.mp4”/>
</SegmentBase>
<SegmentList duration=“10”>
    <segmentURL media=“C2_1024kb_1.mp4”/>....
</SegmentList>
</-- Content C2 at N3=2048kb -->
<SegmentBase>
    Initialization sourceURL=“C2_15sec_500kbit/C1_2048kbit_
    dash.mp4”/>
</SegmentBase>
<SegmentList duration=“10”>
    SegmentURL media=“C1_2048kbit _1.mp4”/>...
</SegmentList>
  ....
</SegmentList>
</MPD>
```

What is claimed is:

1. A management method implemented by a management entity device and comprising:
managing access to description files associated with a content broadcast in real time, wherein reading requires reception, from a communication network, of description files of a first type or of a second type, wherein the managing comprises:
reception, following a request for access to a content, of a description file of the second type and also of successive description files of the first type; and
wherein the description file of the second type received is supplemented over time by at least some of the description files of the first type received successively.

2. The management method as claimed in claim 1, wherein, if received files of the first type and of the second type describe same segments, the segments concerned are read on the basis of the received description file of the first type.

3. The management method as claimed in claim 1, wherein a plurality of description files of the second type are received successively at regular intervals and wherein the reception of a description file of the second type causes deletion of a current description file of the second type.

4. The management method as claimed in claim 1, wherein an update is performed on the basis of all the description files of the first type received.

5. The management method as claimed in claim 1, wherein the update is performed on the basis of some of the description files of the first type received.

6. The management method as claimed in claim 1, wherein the description file of the second type describes a number of segments that is constant over a given time range, and wherein an update of a given number of descriptions of segments via a description file of the first type results in a deletion in the description file of the second type of the same number of descriptions of segments among the first segments of the time range.

7. The management method as claimed in claim 1, wherein the description file of the second type received describes a number of segments over a given time range, and wherein the time range increases over time.

8. A management entity for managing access to description files associated with a content broadcast in real time, wherein reading requires reception, from a communication network, of description files of a first type and of a second type, wherein the management entity comprises:
a processor configured for executing the following steps:
a. receiving, following a request for access to a content, both a description file of the second type and successive description files of the first type; and
b. supplementing the description file of the second type received with at least some of the description files of the first type received successively.

9. A reading device comprising the management entity as defined in claim 8.

10. A non-transitory computer readable data medium on which has been stored at least one set of program code instructions for execution of the management method as claimed in claim 1.

11. A method comprising:
managing transmission of description files associated with a content broadcast in real time, wherein reading requires reception, from a communication network, of description files of a first type or of a second type, wherein the managing comprises transmission, following a request for access to a content, of a description file of the second type and of description files of the first type successively.

12. The method for managing the transmission of description files as claimed in claim 11, wherein the description file of the second type is transmitted after a given period.

13. The method for managing the transmission of description files as claimed in claim 11, wherein the description file of the second type is transmitted after a given number of transmissions of description files of the first type.

14. A management entity for managing transmission of description files associated with a content broadcast in real time, wherein reading requires transmission, via a communication network, of description files of a first type or of a second type, wherein the management entity comprises:
a processor configured for executing the following steps:
c. receiving a request for access to a content, and
d. following the reception of the request for access to the content, transmitting a description file of the second type and description files of the first type successively.

15. A content server, wherein the content server comprises the management entity as defined in claim 14.

16. A non-transitory computer readable data medium on which has been stored at least one set of program code instructions for execution of the management method as claimed in claim 12.
